(19) United States
(12) Patent Application Publication
(10) Pub. No.: US 2003/0177059 A1
(43) Pub. Date: Sep. 18, 2003

(54) Automated advertising method and system including efficacy metric

(76) Inventors: Michael Andrew Smorenburg, San Diego, CA (US); Nikki Tanya Brauer, San Diego, CA (US)

Correspondence Address: BROWN, MARTIN, HALLER & MCCLAIN LLP, 1660 UNION STREET, SAN DIEGO, CA, 92101-2926, US

(21) Appl. No.: 10/347,844

(22) Filed: Jan. 17, 2003

Related U.S. Application Data
(60) Provisional application No. 60/350,328, filed on Jan. 18, 2002.

(51) Int. Cl. G06F 17/60

(52) U.S. Cl. 705/10

(57) ABSTRACT

A service company may use a method and apparatus to provide users paths to client information and obtain user response to client information. The service company provides a user a means for selecting input information based upon which the service company will select an activity to provide to the user. The activity may comprise a game or questionnaire or other means for establishing interactivity with the user. The activity requires input information by the user indicative of a correct statement regarding a client. The activity also includes the option to select a path for the user to access a client's website and recorrect information. Recorded responses are compiled to provide reports to client indicative of correct and incorrect user responses and user menu selections. The user may be provided with incentive rewards for correct answers to questions. Marketing and activity functions are performed at a server maintained by the service company and information is generally provided at a content server of a client.

This application claims the benefit of priority of provisional patent application No. 60/350,328, filed Jan. 18, 2002.

### BACKGROUND OF THE INVENTION

The present invention relates to business data processing and more particularly to a method and system for delivering users to interactive content and for measuring efficacy of the delivery of a message to users.

An extremely important form of marketing to many commercial and non-commercial concerns is the Internet. “Marketing as used here may include advertising. Internet communication has a virtually unlimited reach and the power to provide many different forms of information. People are being continually bombarded by marketing impressions in an ever-increasing number of ways. Advertisements are being placed in places never before imagined. For example, advertisements are now placed on floors of supermarket aisles adjacent shelves of particular products. The consumer's attention is a valuable commodity. Catching the consumer's attention in a cost-effective manner can mean the difference between success or failure for many products and companies.

Finding and targeting consumers is very important since focused marketing is more likely to receive attention. A plethora of techniques exist for selecting information to be provided to Internet users. These include inserting cookies in a user's computer which stored information about web pages a user has accessed. A website may select content to be provided to a user based on the contents of a cookie. Programs exist for collecting information on users who solicit marketing information. Other techniques may be as simple as a host site listing URLs (Universal Resource Locations, i.e., Internet addresses) which a user may select. A service company website must have some reasonable pricing formulation to charge clients. An important form of marketing is one in which the service company delivers users to visit a client's website. Alternatively, a service company may maintain databases containing user information which a client may access. However, most clients prefer having users delivered to their own websites. In this matter, a client may control such perimeters as content and frequency of update of web content.

A traditional pricing formula originating with print media is cost per thousand impressions (CPM). Common methods of Internet pricing include cost per click (CPC), activity pricing and cost per activity (CPA) execution processing. These pricing methods are based on measurement of physical actions of a user. However, they do not give information on the effect of the marketing. The service company does not have any metric indicative of the extent to which material in the marketing is being absorbed by users. It would be useful to provide a pricing method in which a service company could charge in relation to the efficacy of the marketing in terms of being sure that a user got the message. A client would have the satisfaction of knowing that the client is paying for a definite result of a user having learned a message. The client need not worry that perhaps out of sheer perversity a user clicked a particular link to URL many times simply to drive up the client's cost per click price. It would be preferable to have a way which attracts the user to not only view the client's message but to learn it.

### SUMMARY OF THE INVENTION

Briefly stated and in accordance with the present invention, there are provided a method and apparatus in which a service company provides users paths to client information and obtains user responses to client information. The path to the client information will commonly provide a hyperlink to a client's website. The service company provides a user a means for selecting input information on which the service company will select an activity to provide to the user. The option provided to the user in a preferred form comprises a menu of incentives. The activity is comprised in a webpage accessible to the user. The activity may comprise a game or questionnaire or other means for establishing interactivity with the user. The activity is set to require response by the user indicative of a correct statement regarding the client. Information regarding the client could regard the client institution or its services or products. The activity also includes a path for the user to access a client's website. The service company registers the user's responses. Recorded responses may be compiled to provide client's reports indicative of correct and incorrect user responses and user menu selections. The user may be provided with an incentive reward for correct answers to questions. Incentives may include “points” redeemable for various items, entries and prize drawings or prizes themselves. In a further form, additional information may be collected on users, such as geographic locations and expressed and implied interest. All responses by users may be utilized for market segmentation and for generation of further activities from a local database to be presented to a user.

### BRIEF DESCRIPTION OF THE DRAWINGS

The invention, both as to its organization and manner of operation by reference to the following description taken in connection with the following drawings.

Of the drawings:

FIG. 1 is a block diagram of a telecommunication system in which a user, clients and a service company are interconnected;

FIG. 2 is a block diagram of a processor at an service company location;

FIG. 3 is a flow diagram illustrating a basic operation in dealing with the user;

FIG. 4 is a flow diagram illustrating further optional operations beyond the operation of FIG. 3;

FIGS. 4-8 are illustrations of webpages presented on a monitor screen illustrating one form of performance of a method in accordance with FIG. 4;

FIGS. 9-11 are illustrations of forms that may be presented on a screen illustrating software in an marketing module interacting with an marketing database;

FIG. 12 is a form illustrating software interacting with an accounting module;

FIG. 13 is a flow chart illustrating the provision of missions within activities to a user and response thereto; and

FIG. 14 is a flow chart illustrating a prize selection and award process.

### DETAILED DESCRIPTION

The present system and method allows clients to reach audiences of users and engage users into communication regarding details of the client's message regarding its institution, products, services, and other interactions with the world. Rather than just broadcasting a statement in an open loop system manner, the invention recognizes responses from users that imply cognitive feedback. This system prompts the user to visit a client's internet site to find correct answers and provides a path to the correct answer and back to the system itself. This system recognizes correct answers and creates records indicative of receipt of correct answers. In this manner, a metric can be generated indicative of efficacy of a client's efforts in educating its audience. The user can be instantly rewarded through points. The points may provide instant access to goods or services or to prize drawing entries.

The invention allows a client to employ a campaign which may communicate to the general user audience one or a number of messages. The campaign may be divided into particular activities. An activity is a game, questionnaire, survey or other routine which can supply a stimulus to a user and respond to and record a response by a user. Within each activity, missions are provided. A mission is a discrete unit of an activity such as, for example, presentation of one question and a set of multiple choice answers, along with a path, such as a hyperlink to a client's website where the answer be found. The missions may be constructed such that the only way for the users to find the answers and consistently fulfill, i.e., answer correctly, missions and gain incentive awards is by following the hyperlinks and actively navigating the client's website until users find and comprehend the key marketing message.

Revenue is generated and justification of value may be maintained according to a pricing matter that may utilize a cost per delivery (CPD) payment pricing model. The invention enables the advertiser to pay only for delivered results, i.e., evidence that the user has learned the client's message. Other elements of conventional pricing schemes may also be used.

The invention further provides the option of automatically segmenting users into different categories. Segmentation may be done by prize selections offered to users or through specific or inferred data analysis of data supplied by users in response to stimulus such as questionnaires and registration routines.

Through use of the present invention, a user experience may be populated with missions that relate to the defined or implied interests of users. The invention may correlate particular missions with particular user profile characteristics and in accordance with marketing module software present missions based on the user market segmentation. Efficient administration is also provided as further described below. It should be noted that terms such as campaign, activity and mission are arbitrary and are used for clarity in description of operations to be performed. These descriptions in no way limit functionality of the invention. While particular hardware and software architectures are illustrated, many widely known equivalents are available to those skilled in the art.

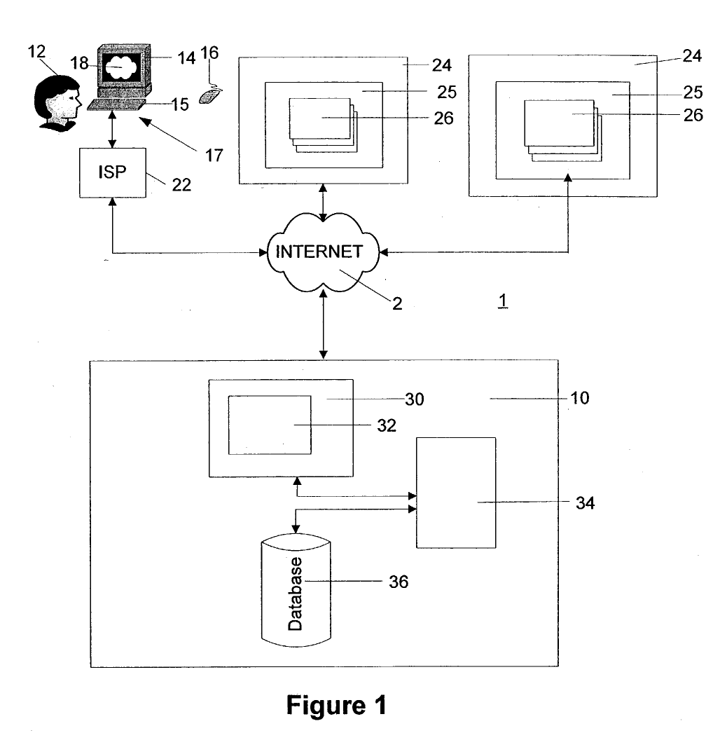

FIG. 1 illustrates a telecommunication system 1 including a communications network which will most commonly comprise the Internet 2. A service company 10 provides an interactive experience for a user 12 at a user terminal 14. The terminal 14 includes devices such as a keyboard 15 and a mouse 16 at a user interface 17. Many other forms of user interface devices are known. The user terminal 14 also comprises a screen 18 displaying information. The terminal 14 interfaces to the Internet 2 via an Internet service provider 22. The service company 10 acts on behalf of clients 24 each having a content server 25. The content server 25 provides connection to client websites and the full variety of content available through a telecommunication system. The service company 10 provides the clients 24 with the opportunity to educate the user 12 and provides the users 24 metrics regarding the efficacy of this education. The service company 10 can record actions of users, “click through” rates indicative of the number of levels of a client website 26 through which a user 12 has entered and other metrics regarding user activity. The client 24, by virtue of having marketing efficacy metrics available, gains the ability to compensate the service company 10 based on the level of consumer education achieved rather than compensating merely based on the number of clicks. The service company 10 includes a marketing server 30 hosting a marketing website 32. It should be noted that terms such as content server and marketing server are arbitrary. They are used to facilitate clarity and description of interactions in the system 1. They do not indicate a particular necessity for difference in the structures of various servers. The marketing server 30 communicates with a processor 34 which may also interact with a database unit 36.

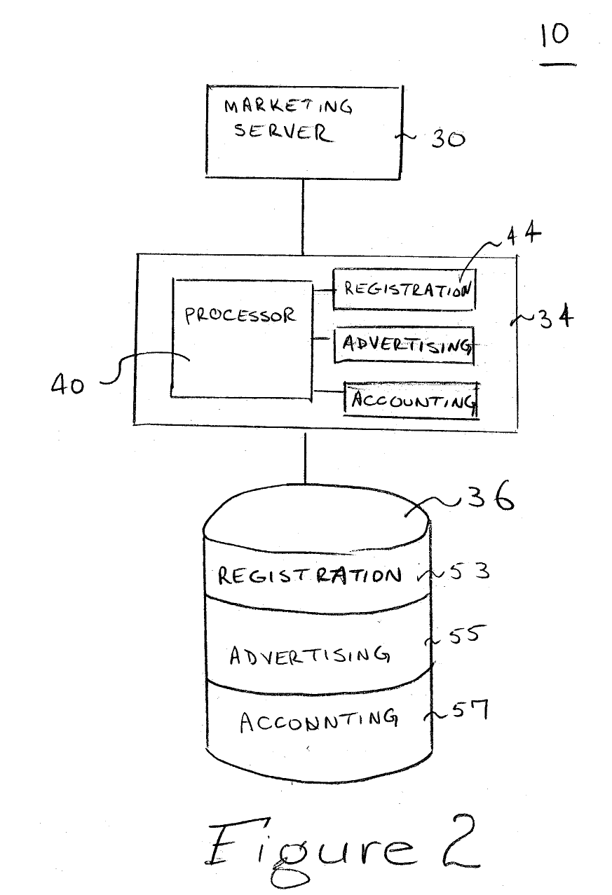

FIG. 2 is a block diagram of one form of data processing and communication system included in a service company 10. The same reference numerals are used to denote components corresponding to those in FIG. 1. The processor 34 receives communications from the server 30. The computer 34 includes a processor 40. The processor 40 includes appropriate modules for performing various functions described below. The modules need not correspond to individual hardware modules. The modules may be implemented through software modules or may be integrated with each other. However, their operation may be represented by individual modules. In the illustrated exemplification, the processor 40 includes a registration module 42, an marketing module 44 and an accounting module 46. The computer 34 may further include its own memory 50 as well as interacting with the database unit 36. The database unit 36 may include individual databases such as a registration database 53, an marketing database 55 and an accounting database 57. The registration database 53 may contain, organize and manipulate data regarding information collected from users 12. This may include intellectual property addresses, demographic information supplied by users 12 and other data customer associated with users. The marketing database 55 may include client content. However, client content will preferably be provided at content servers 25 (FIG. 1). The accounting database 57 may include billing and communication information and report forms for providing bills, reports and other services to the clients 24.

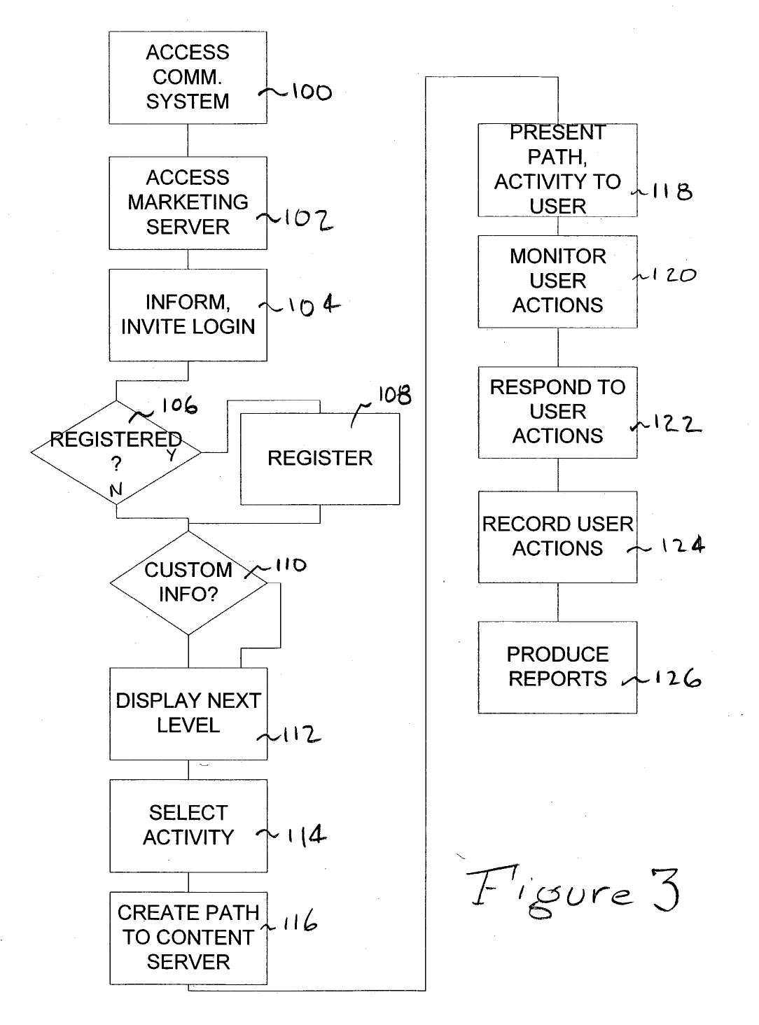

Operation of the system is described with respect to FIG. 3, which is a flow diagram indicative of interaction of the user 12 in the system 1. The invention comprehends a machine readable medium as well as a method. A machine-readable medium includes any mechanism that provides (i.e, stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.) At block 100, the user 12 accesses the communication system 1. The user 12 may “surf the net” accessing various sites in a conventional manner too. At block 102, the user 12 accesses website 32 at the marketing server 30. Entry may be direct or from a website 26. At block 104, the computer 34 accesses marketer content from the memory 50 or the marketing database 55. At this point, the user 12 is invited to log into the marketers site 32. Logging in conventionally comprises entry of a user name and password by the user 12 at the user terminal 14. Alternatively, log-in could occur at website 26 if the user is registered, as indicated as block 106 then operation proceeds to block 110 in which the registered user page is presented. If the user is not registered, operation proceeds to block 108 at which a user can register. Registration conventionally comprises selection by the user of a user name and password.

The registration database 53 examines a suggested user name entered by a user 12 to require uniqueness. In this manner, information on each registered user may be maintained. At a minimum, this information will include the user 12's password so that entry of a unique user 12 may be validated. Registration routines generally require entry of a valid email address. Other routines may ask further demographic information of a user such as postal code, age bracket and other personal information. More specific information could also be requested. Once a user has registered, operation proceeds to block 110. In the alternative, the simplest form of registration, checking at block 106 could provide checking for a cookie which has been inserted in a conventional manner in the user terminal 14. In the alternative to entering registration information in the registration database 53, the computer 34 may simply generate a cookie. At block 110, the user 12 is provided entry to a next level of the website 32.

At this point, the computer 40 checks for custom information associated with the user 12, whether in a cookie or in the marketing database 53, and at block 112, a next level of the website 32 is displayed. Where no stored information is associated with the user 12, the next level comprises information and a menu of available activities. Activities may include games, surveys, or other forms of interactive routine susceptible of provision of a stimulus to a user and a response perceptible by the computer 42. A stimulus may include provision of a question to a user and a response is some action at the user interface 17 of the user terminal 12 (FIG. 1) which is perceptible by the computer 40. In the case of information having been stored for a user 12, the computer 40 will access that display and select a next level at the block 112 which may include identification of desired incentives selected by the user 12, a number of points accumulated toward achievement of being entitled to request the incentive and a report on an in-progress activity which has been stored.

At block 114, the user 12 selects an activity. Each activity is associated with a client 24. The service company 10 desires to establish that the user 12 is educated with respect to the client 24. At block 116, a path to a client 24 is created. Most commonly, this will be achieved by providing a hyperlink to a website 26 at a content server 25. At block 118, the path and the activity are presented to the user 12. The user 12 then proceed to answer questions or respond to other stimuli presented by the activity. At block 120, user actions are recorded. At block 122, user actions are responded to. The actions user 12 may take include answering answers. A response to a user action can include evaluation of whether an answer is correct and providing a response at block 122 to the user indicative of whether the response was correct. The information supplied to the user could also include a suggestion to select the path presented at block 118 so the user can learn more. A response to a user action can include awarding of points produced in response to a correct answer. This response may further include provision of a message to a user informing of the gaining of points and informing of whether the user has reached a particular point threshold.

At block 124, user actions are recorded. Recorded user actions can include entry of correct answers, entry of incorrect answers, taking of the path via hyperlink to a client 24's content server 25 and the time and depth of connection to different levels of the client website 26. At block 126, reports are produced. Reports are produced by data reduction of data recorded in response to all users 12 or may be broken down with respect to users 12 in particular categories. The reports may include information on learning of content information, amount of traffic to websites produced in response to messages to users 12, popularity of selected incentives and popularity of selected games. Importantly, the reports may also include reports to clients 25 of the efficacy of the games in teaching consumers the content of websites 26. Significantly, for the service company 10, the reports may also include billing to clients 25 for education results delivered.

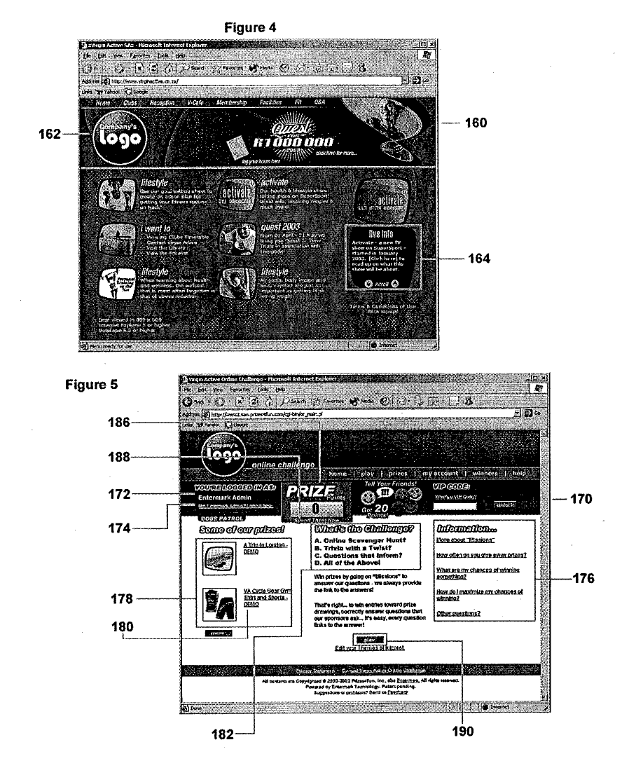

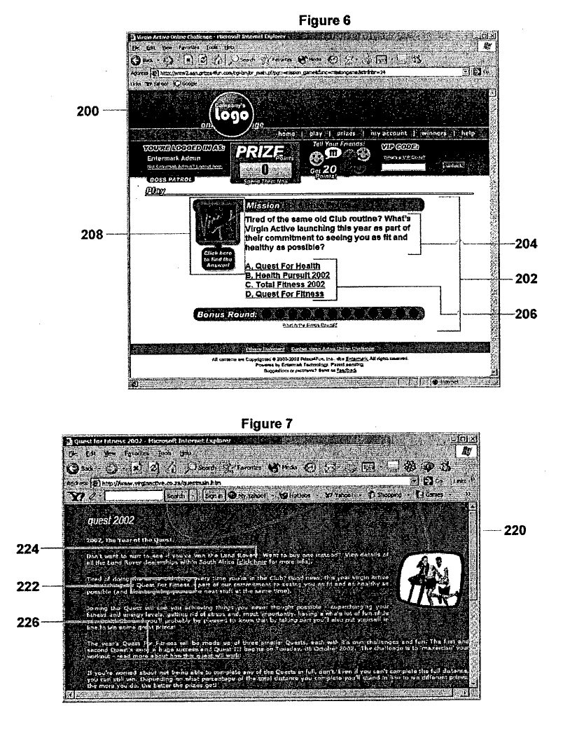

FIGS. 4 through 7 illustrate an example of performance according to FIG. 3. As seen in FIG. 4, a client webpage 160 is illustrated at a client website 26. The page 160 includes client information such as a logo 162 and options and includes a box 164 which may be selected to enter an activity. Selection on the box 164 takes the user 12 to a service company webpage 170 maintained by the service company 10 on behalf of a client 24. The page 170 includes a field 172 for identification of a client, a field 174 identifying the user in accordance with registration information and may also include a menu 176 providing an entrance for the user 12 two pages explaining answers to frequently asked questions. Various prizes may be displayed at boxes 178 with links 180 to provide information about the prizes 178. An activity menu 182 gives the user 12 an option to select various activities. A status box 186 provides a user information on points accumulated. An option box 188 is provided to give the user an option to enter a menu in which the points may be redeemed. In order to begin an activity, the user 12 may click on a “play” box 119. The box 119 indicates that the user 12 will proceed. “Play is one of many ways to denote the option to proceed.

Taking of this action will bring the user 12 to an activity screen 200 illustrated in FIG. 6. At this screen, a question field 202 is provided with a question 204 and multiple choice answers 206. The question and answer fields are derived from the marketing database 55 (FIG. 2). The marketing module 44 selects the question field 202 in accordance with identity of the client 24 and may also monitor identity of the user 12 so that particular questions 204 are not frequently repeated for the same user 12. The question 204 challenges a user 12 to learn details about the client 24 and its facets. The question field 202 also includes a link 208, which in the example of FIG. 6 is labeled, “click here to find the answer.” The field 208 provides a path to information regarding the client and particularly regarding information concerning the subject of a question 204. Selection of the path 208 will take the user 12 to the screen illustrated in FIG. 7.

FIG. 7 is an illustration of a webpage 220 at a content server 25. The page 220 includes an answer to the question 202 in a field 222. Further links 224 are provided on the page 220. The links 224 may provide links to information from a co-branding sponsor having a website on another one of the content servers 25. Another link 226 may take the user 12 to further pages within the client 24's own website. The user 12 may return to the screen 200 (FIG. 6) to answer the question and accumulate points.

In FIG. 8, an accessible screen 230 is illustrated showing the prize information field 188 after the user has accumulated a number of points. The screen 230 includes prize fields 232 demonstrating different prizes. Links 234 allow user 12 to select them to get further information on the different prizes and to utilize points to redeem the prizes. In the present exemplification, the prizes are entries to a drawing. In other embodiment, prizes could include t-shirts, posters or other items.

A VIP code field 236 is provided. The VIP code may be employed in the alternative to completing missions. Alternatively, VIP codes may be given in advertising or granted as incentives. This can be used to measure response to print or broadcast advertising. They would be provided under soft dink caps or by other user actions.

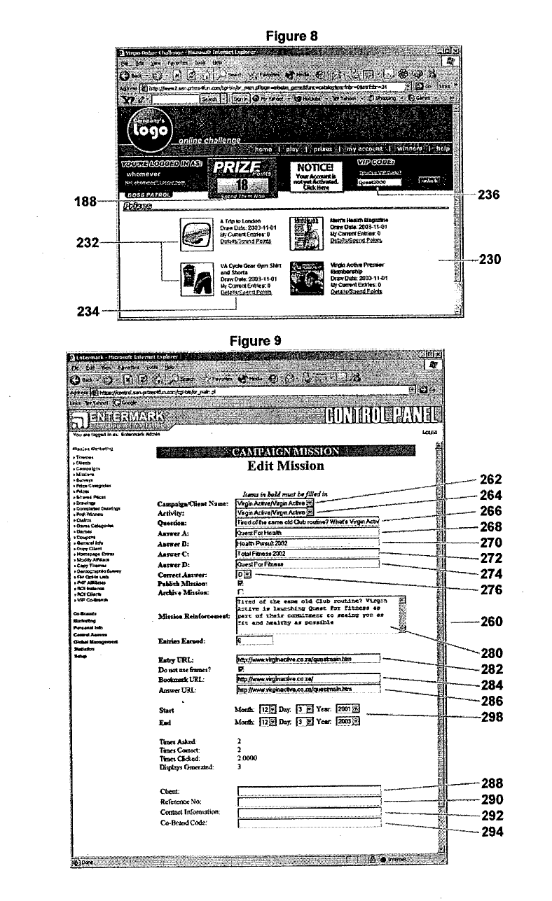

FIG. 9 illustrates administrative software which may be operated by the service company 10 or the client 24. FIG. 9 is an illustration of a form 260 for interacting with the marketing database 44. Field 262 includes an identification of the client. Field 264 includes an identification of the particular activity in which a question is going to be included. Field 266 through 276 are provided respectively for receiving a question, four multiple choice answers and the correct answer. The correct answer comprises a preferred response. At least one field 280 is provided for providing re-enforcement message triggered by a preferred response or another message triggered by a non-preferred response. In the present exemplification, the re-enforcement is further information, for example, regarding a discount or other consumer incentive. URL fields 282, 284 and 286 are provided to respectively a locator from which a user 12 will enter the particular activity, the home page of the client website 26 (FIG. 2) and the URL to which a user is taken when requesting a correct answer.

A client record must also be created which may be used by both the marketing database and accounting database 57. In practice a separate form may be utilized for the client record, but for simplicity and illustration, the client record is included in the form 262. Client identity is provided in a field 288, and a reference number may be associated with the client in a field 290. By contact information such as telephone, postal address and email address is provided in field 290. A co-brand code may be entered in field 294. A particular client may work with other entities such as cooperating advertisers or organization sponsors. The co-brand is that of another organization.

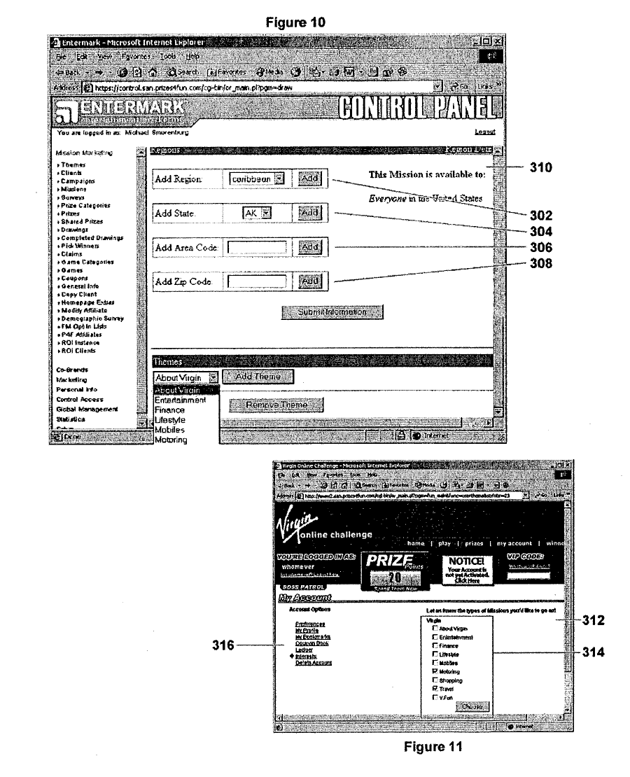

One client 24 may have many campaigns. A campaign is a cohesive advertising, marketing or teaching program. For example, the campaign may include a plurality of activities. An activity is a questionnaire, a game or other interactive endeavor presented to a user 12. A campaign may have its own budget, its own cost per delivery or cost per click, reporting email and individual logo. A campaign can have its own report (described with respect to FIG. 12 below). A set of date fields 298 may be provided for automatic enablement and disablement of presentations of particular campaigns from the marketing database 55 (FIG. 2).

Each activity or campaign may include any number of missions. A mission is a discreet unit to be presented to a user 12 and receiving a response. For example, a mission may be one question of a quiz or a survey. A mission may be one turn of a game.

FIGS. 10 and 11 respectively illustrate software for tailoring information provided from an marketing database 55 to a particular user 12. In FIG. 10, a screen 300 is illustrated in which fields 302, 304, 306 and 308 are provided in which a user can indicate geographic location with varying levels of specificity. In a field 310, information regarding an activity can be provided which indicates geographic areas to which that particular activity is available. FIG. 11 illustrates a screen 312 providing a menu 314 including a list of interests which a user may select. A user account may include a number of aspects which a user may access. These aspects need not be on screen 312 but can be on other screens. They are shown here to indicate one of the many options. A menu 316 provides links to take users to information fields where they can enter preference information regarding such things as displays, profile where personal information is entered, a ledger showing accumulation and use of points and other such user specific fields.

FIG. 12 is an example of a report which may be provided as a monthly report to a client 24. FIG. 12A is a period by period report of the number of questions served to user's requesting questions, the number correctly answered, a price, currently delivery and a total. In this particular exemplification, the client might be charged $1.00 per correct answer received from a user. FIG. 12(b) represents survey information which a client may embody in the activities. In this particular example, users have answered what sorts of stores they buy bath salts in. A breakdown of numbers and percentages is provided and a link to further breakdowns by demographics is provided. Thus the client receives further marketing information by which to target marketing. FIG. 12(a) may be derived from the accounting database 57 (FIG. 2).

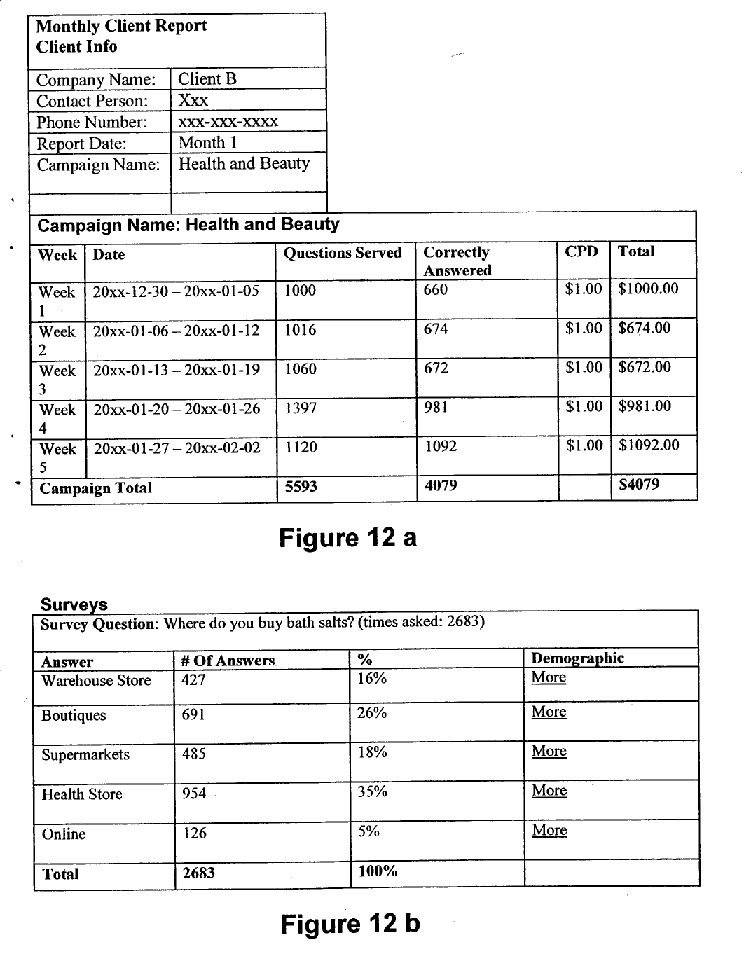

FIG. 13 is a flow diagram of another form of activity, in particular a game which may be practiced in accordance with the method of FIG. 3. At the starting box 400 of FIG. 13, it is assumed the user 12 is already signed in and has reached an entry page such as the page 170 of FIG. 5 at which an activity may begin. At block 400, the user 12 collects a desired prize. At block 402 a mission is selected, the mission is the information that will be accessed from the marketing database 55 (FIG. 2) in correspondence with the selection performed at block 400. The mission may be derived as a look up table response through any other form of database management. The mission may open up a game board on the display 18 of the user terminal 14 (FIG. 1). The selection at block 400 may invoke a game reference number identification that identifies the game and what game file to call. At block 404, the marketing database 57 may check what questions were last provided to the particular user 12. Previously used questions are assigned a low priority in the mission pool, and questions which have not been presented to a user are given a higher priority for presentation to the user 12 in the mission pool. Therefore, block 404 is labeled arrange mission pool. A pool of questions for user is created. Alternative methods may be used to select arranged in mission pool as well. A mission is an operation that can be performed correctly or incorrectly by a user 12. A plurality of missions, or on occasion assembled mission comprise an activity. When the user registers a list of all current missions is created and assigned to the user, with each admission having a score of zero. When the user answers a mission correctly, that mission's score is increased by one. Once all of the missions on a user's list have a score of one or higher, every mission has one deducted from its score. The marketing module 44 (FIG. 2) uses one of a number of ways to determine which mission it should ask a user. Which method may be determined by the following criteria:

(1). If the user 12 is playing a game that dictates a particular activity, then the mission will be selected from all missions in that particular activity. Preference is given to missions with a scope of zero (or the lowest score if none have a score of zero). If the user 12 is not performing an activity that dictates missions, then the following step is proceeded to;

(2) If there are any missions in the “top 10” mission list, the mission will be the highest mission with a score of zero. If no missions in this list have a score of zero (because they have all been asked), then the next step is proceeded to:

(3) (a) If the user is playing for a prize, the selection of which corresponds to a setting of “use prize theme,” then the mission is randomly selected from all missions in a theme correlated with that prize. Preference is given to missions with a score of zero. If no missions have a score of zero, then step 4 is proceeded to;

(b) in the alternative to 3(a) if the user is playing for a prize that is said to “use player themes,” then the mission is randomly selected from activities that a user has selected at a particular menu as a favorite. Again, preference is given to missions with a score of zero. If no missions have a score of zero, then the next step is followed. If the system has gotten to this step from step 3(a) it will try to find a mission with a score of zero using the method of 3(b).

If no missions have a score of zero, all missions will have one deducted from their score. A mission may be pulled at random from all available missions that have a score of zero.

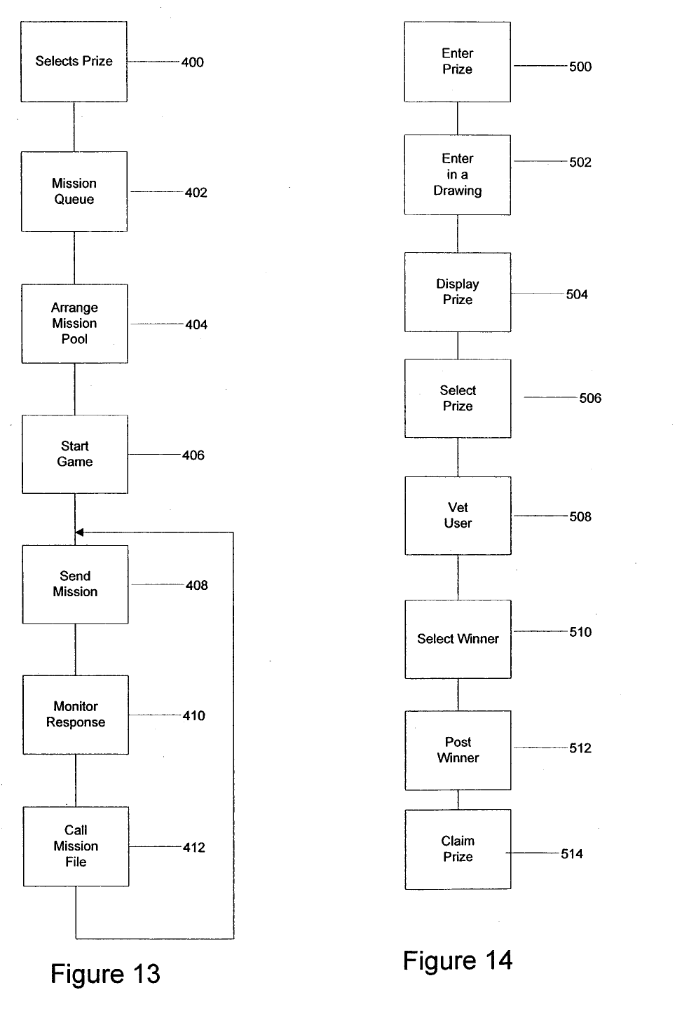

At block 406, the user 12 will start the game. The game may be started by clicking on a button such as “earn more coins” or “answer mission.” The marketing module at block 408 sends a mission. The mission may include a question and four answers, the number of points the mission is worth, the path to the client information at block 410, the marketing module 44 responds to the user selection. If the user answers correctly, the points are awarded and the user is returned to a next step in the game. If the user 12 answers incorrectly, points may be lost. The user may be asked another mission until one if finally answered correctly or the user may be returned to another branch in the game. This step is indicated at block 412 entitled “call mission file.” Operation may return to block 408 so that further questions are answered. FIG. 14 is a flow chart illustrating entry of a prize in a prize inventory of the marketing database 55. Before prizes entered in a drawing, it must first be entered in a prize category. This is done under a prize function. At block 500, the prize is entered. Fields of information for the prize including prize name, descriptions, quantity, value, size, and further information, may be stored in the prize table. A prize form analogous to the question or mission form of FIG. 12 may be provided.

After the prize is placed in a prize inventory, it is entered in a drawing at block 502. Again another data field may be established for administering entry of the prize. Drawings may be daily, weekly, monthly or a periodic. There may be grand prize drawings and small prize drawings. When a game drawing is created, a prize is selected from a prize inventory and associated with a particular drawing. A drawing is associated with other data including start and end dates, whether it will be shared by a charity, the number of days in which a winner must claim the prize and whether the prize will go to a charity if no winner claims it. At block 504, the prize is displayed in a game site. When a drawing is created, it can be predetermined to be a game drawing or a grand drawing. The drawing is displayed on a selected page, for example, page 170 of FIG. 5. At this point, the prize is available for selection by a user. At block 506, the user selects a prize. Block 506 in FIG. 14 corresponds to block 400 of FIG. 13. At block 508, eligibility of a user is vetted. A user may be restricted to win only one game drawing within a certain number of days at block 510, a winner is selected. The game prize winner may be drawn from users who have not won within a certain restricted time period. Alternatively, the marketing module 44 may not make any distinction with respect to whether a user has won a prize recently. At block 512, the winner is posted. The user 12 may be emailed if they have provided an email address such as at registration step 108 of FIG. 3. Alternatively, the notice may simply be posted at a site at one of the above-described pages. The winner may complete the prize winning process at block 514 by claiming the prize.

The disclosure will enable those skilled in the art to instruct many embodiments in accordance with the present invention.

What is claimed is:

1. A method comprising:
providing to a user at least one category from which to make a selection;
registering a selection by the user;
providing, in response to the selection a mission, said mission comprising:
a stimulus,
a plurality of response options, one of the response options comprising a preferred response option and
a path to a content site, the preferred response in said mission being correlated with content at the content site perceptible to the user; registering a selection of a response by the user; and
providing a response to the user in correspondence with whether or not the response indicates selection of the preferred response.

2. The method of claim 1 further comprising establishing an incentive account for the user and incrementing said account in response to receipt indicating selection by the user of a preferred response in response to a stimulus.

3. The method of claim 2 further comprising providing the user a next mission after selection of a next response.

4. The method of claim 3 comprising grouping a preselected number of missions into an activity, detecting a response by a user indicative of completion of an activity and providing the user a message in response to completion of an activity.

5. The method according to claim 4 further comprising registering correct and incorrect responses of a user.

6. The method according to claim 5 further comprising registering user selection of the path and user activity at the destination of said path.

7. The method according to claim 6 further comprising generating a report indicative of user correct answers.

8. The method according to claim 7 further comprising registering the occurrence of selection of non-preferred alternative responses, visits by the path to the destination and subsequent user selections of preferred responses.

9. The method according to claim 8 wherein said mission comprises a multiple choice question.

10. The method according to claim 9 wherein said mission comprises a game move.

11. A machine readable medium that provides instructions which when executed by a processor cause said processor to perform operations comprising:
providing to a user at least one category from which to make a selection;
registering a selection by the user;
providing in response to the selection a mission, said mission being included in the category associated with the category selected by the user, said mission comprising:
a stimulus,
a plurality of response options, one of the response options comprising a preferred response option and
a path to a content site, the preferred response in said mission being correlated with content at the content site perceptible to the user;
registering a selection of a response by the user; and
providing a response to the user in correspondence with whether or not the response indicates selection of the preferred response.

12. The machine readable medium of claim 11 further comprising instructions to cause establishing an incentive account for the user and incrementing said account in response to receipt indicating selection by the user of a preferred response in response to a stimulus.

13. The machine readable medium of claim 12 further comprising instructions to cause providing the user a next mission after selection of a next response.

14. The machine readable medium of claim 12 further comprising instructions to cause grouping a preselected number of missions into an activity, detecting a response by a user indicative of completion of an activity and providing the user a message in response to completion of an activity.

15. The machine readable medium of claim 12 further comprising instructions to cause registering correct and incorrect responses of a user.

16. The machine readable medium of claim 12 further comprising instructions to cause registering user selection of the path and user activity at the destination of said path.

17. The machine readable medium of claim 12 further comprising instructions to cause generating a report indicative of user correct answers.

18. The machine readable medium of claim 12 further comprising instructions to cause registering the occurrence of selection of non-preferred alternative responses, visits by the path to the destination and subsequent user selections of preferred responses.

19. The machine readable medium of claim 12 further comprising instructions to cause said mission to comprise a multiple choice question.

20. The machine readable medium of claim 12 further comprising instructions to cause said mission comprises a game move.

21. A system comprising a marketing server to provide interfaced to a telecommunication system;
a processor coupled to said marketing server and to a database, said processor comprising:
a registration module,
an marketing module, and
an accounting module, said marketing module causing provision to a user of alternative categories selections and responding to a selection of said user to provide missions to the user comprising a stimulus, plurality of responses, one of which comprises a preferred response and a path to a content server comprising content correlated with contents of the mission; and
an marketing database coupled to said processor containing said missions.

22. The system according to claim 12 further comprising means for registering selections by a user of preferred alternatives and providing responses to the user in accordance with whether the selections are or are not in correspondence with the preferred response.

23. The system according to claim 13 wherein said processor registers preferred selections by a user and records activity of the user in selecting the path and activity at a destination accessed by the path.

24. The system according to claim 14 where said processor generates reports indicative of learned correct responses by a user subsequent to selection of the path.

25. The system according to claim 15 wherein said processor comprises an accounting modules for generating reports indicative of user activity and user learning of preferred responses.
